(19) United States
(12) Patent Application Publication
(10) Pub. No.: US 2023/0255326 A1
(43) Pub. Date: Aug. 17, 2023

(54) WEARABLE ELECTRONIC DEVICE COMPRISING FASTENING STRUCTURE

(71) Applicant: SAMSUNG ELECTRONICS CO., LTD., Suwon-si (KR)

(72) Inventors: Jin SAGONG, Suwon-si (KR); Ikhyun CHO, Suwon-si (KR); Kiwook HAN, Suwon-si (KR); Daegyu KANG, Suwon-si (KR)

(21) Appl. No.: 18/298,683

(22) Filed: Apr. 11, 2023

Related U.S. Application Data
(63) Continuation of application No. PCT/KR2021/016382, filed on Nov. 11, 2021.

(30) Foreign Application Priority Data
Dec. 7, 2020 (KR) 10-2020-0169690

(51) Int. Cl. A44C 5/14

(52) U.S. Cl. CPC A44C 5/14; G04G 17/00

(57) ABSTRACT

A wearable electronic device according to an embodiment of the present disclosure comprises: a display that forms a front surface of the wearable electronic device; and a frame part that surrounds the display and forms at least a part of the exterior of the wearable electronic device, wherein the frame part comprises a fastening part to which a strap for assisting wearing of the wearable electronic device is coupled, the fastening part comprises a first coupling part, and a second coupling part spaced apart from the first coupling part by a specified distance, the first coupling part comprises a first groove into which a fastening structure of the strap can be inserted, and a second groove to which the fastening structure of the strap can be fixed, the second coupling part comprises a fourth groove to which the fastening structure of the strap can be fixed, and the fastening structure of the strap may be at least inserted into the first groove and fixed to the second groove and the fourth groove. According to various embodiments of the present disclosure, since a guide groove is provided in a fastening part of a frame part of a wearable electronic device, a user can easily fasten a strap without determining an exact position thereof, and it is possible to prevent and/or reduce damage to the wearable device or the strap that occurs in the process of determining the exact position of a hole provided in the wearable electronic device.

### CROSS-REFERENCE TO RELATED APPLICATIONS

This application is a continuation of International Application No. PCT/KR2021/016382 designating the United States, filed on Nov. 11, 2021, in the Korean Intellectual Property Receiving Office and claiming priority to Korean Patent Application No. 10-2020-0169690, filed on Dec. 7, 2020, in the Korean Intellectual Property Office, the disclosures of which are incorporated by reference herein in their entireties.

### BACKGROUND

### Field

The disclosure relates to a strap fastening structure in a wearable electronic device.

### Description of Related Art

Recently, various types of wearable devices have been developed to further increase the portability of portable electronic devices. For the portability of wearable devices, there may be various auxiliary devices that assist in carrying or wearing the wearable devices.

In particular, with the presence of straps that assist in wearing in relation to watch-type wearable devices, the portability and wearability of the electronic devices may be improved.

According to the prior art, when fastening a strap having a pin spring structure to a wearable device, it may be difficult to determine an exact position because it is necessary for a user to pull the pin and then to release the pin to be accurately aligned with a hole in the wearable device.

In addition, according to the related art, when fastening the strap having the pin spring structure to the wearable device, it may be difficult for a user to pull a small pin and to find an exact recess position.

Furthermore, according to the prior art, in the process of determining the exact position of the hole in the wearable device, the wearable device or a fastening structure of the strap may be damaged.

### SUMMARY

A wearable electronic device according to an example embodiment disclosed herein may include: a display defining a front surface of the wearable electronic device, and a frame surrounding the display and defining at least a portion of an exterior of the wearable electronic device. The frame may include a fastening portion to which a strap configured to assist the wearing of the wearable electronic device is coupled. The fastening portion may include a first coupling portion and a second coupling portion disposed to be spaced apart from the first coupling portion by a specified distance. The first coupling portion may include a first recess into which a fastening structure of the strap comprising a protruding pin is inserted, and a second recess to which the fastening structure of the strap is fixed, and the second coupling portion may include a third recess to which the fastening structure of the strap is fixed. The fastening structure of the strap may be inserted into at least the first recess and may be fixed to the second recess and the third recess.

According to various example embodiments of the disclosure, since a guide recess exists in a fastening portion of a frame of a wearable electronic device, a user may easily fasten a strap without determining an exact position.

According to various example embodiments of the disclosure, a wearable device or a strap may be prevented and/or reduced from being damaged in the process of determining an exact position of a hole in the wearable electronic device.

Effects that may be obtained based on various embodiments are not limited to those described above, and other effects not described above will be clearly understood by a person ordinarily skilled in the art to which the disclosure belongs based on the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 includes perspective views illustrating a wearable electronic device to which straps are fastened according to various embodiments;

FIG. 2 is a diagram illustrating a strap fastened to a wearable electronic device according to various embodiments;

FIG. 3 is a diagram including a side view illustrating a wearable electronic device to which straps are fastened according to various embodiments;

FIG. 4 is a diagram including a side view illustrating a process of fastening a strap to a wearable electronic device according to various embodiments;

FIG. 5 is a diagram illustrating a rear view of a process of fastening a strap to a wearable electronic device according to various embodiments;

FIG. 6 is a diagram illustrating an example in which a fastening structure of a strap is inserted into a guide recess of a fastening portion existing in a frame of a wearable electronic device according to various embodiments;

FIG. 7 is a diagram illustrating an example of a process in which a fastening structure of a strap is inserted into and fastened to guide recesses of a fastening portion existing in a frame of a wearable electronic device according to various embodiments; and

FIG. 8 is a diagram illustrating an example of a process in which a fastening structure of a strap is inserted into and fastened to guide recesses of a fastening portion existing in a frame of a wearable electronic device according to various embodiments.

### DETAILED DESCRIPTION

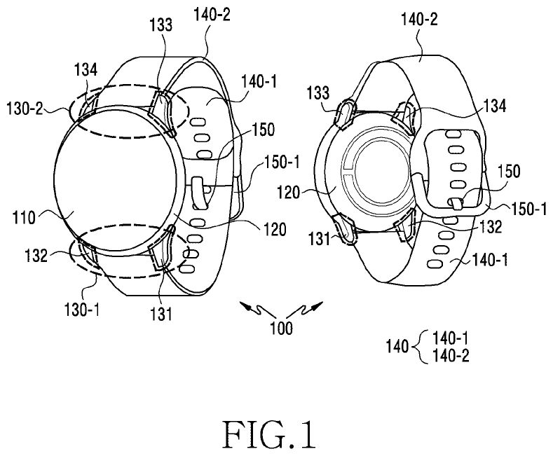

FIG. 1 includes perspective views illustrating an example wearable electronic device to which straps are fastened according to various embodiments.

In various embodiments, the wearable electronic device 100 of FIG. 1 is illustrated as including straps 140-1 and 140-2, but in the following description of the wearable electronic device 100, conceptually, the straps 140-1 and 140-2 may or may not be included in the wearable electronic device 100 for convenience of description. For example, in describing a process of coupling the straps 140-1 and 140-2 to the fastening portions 130-1 and 130-2 included in the frame 120 of the wearable electronic device 100, the description may be made on the straps 140-1 and 140-2 not being included in the wearable electronic device 100. As another example, in describing a structure in which the straps 140-1 and 140-2 are coupled to the fastening portions 130-1 and 130-2 of the wearable electronic device 100, the description may be made based on the straps 140-1 and 140-2 being included in the wearable electronic device 100.

According to an embodiment, the wearable electronic device 100 may include a display 110, a frame 120, fastening portions 130-1 and 130-2 included in the frame 120, and straps 140-1 and 140-2.

In an embodiment, the display 110 may define the front surface of the wearable electronic device 100. For example, the display 110 may configure the front surface of the wearable electronic device 100 by being disposed on the frame 120. In addition, the frame 120 may define at least a portion of the exterior of the wearable electronic device 100 while surrounding the display 110, and the display 110 may define at least a portion of the exterior of the wearable electronic device 100 on the frame 120.

In an embodiment, the frame 120 may define the side surface and the rear surface of the wearable electronic device 100. For example, the frame 120 may have a structure surrounding the display 110 defining the front surface of the wearable electronic device 100 and may define the side surface and the rear surfaces of the wearable electronic device 100 while surrounding the display 110.

In an embodiment, the frame 120 of the wearable electronic device 100 may include fastening portions 130-1 and 130-2. For example, the frame 120 defining at least a portion of the exterior of the wearable electronic device 100 may include fastening portions 130-1 and 130-2 to be fastened with the straps 140-1 and 140-2. The fastening portions 130-1 and 130-2 may be portions of the frame 120 and may be portions for fastening between the straps 140-1 and 140-2 and coupling portions (e.g., the first coupling portion 131, the second portion 132, the third coupling portions 133, and the fourth coupling portions 134.

In an embodiment, the fastening portion 130-1 may include a first coupling portion 131 and a second coupling portion 132, and the fastening portion 130-2 may include a third coupling portion 133 and a fourth coupling portion 134.

In an embodiment, the first coupling portion 131 and the second coupling portion 132 may be spaced apart from each other by a predetermined (e.g., specified) distance. In addition, the third coupling portion 133 and the fourth coupling portion 134 may also be spaced apart from each other by a predetermined distance. For example, the aforementioned predetermined distance may be a distance corresponding to the width of the straps 140-1 and 140-2, or may be greater than the width of the straps 140-1 and 140-2.

In an embodiment, holes (e.g., the hole 150) for inserting a pin of a locking device 150-1 may be provided in the first strap 140-1. For example, multiple holes may be arranged at regular intervals in the first strap 140-1, and a user inserts a pin of the locking device 150-1 into one of the multiple holes (e.g., the holes 150) to fit his/her body.

In an embodiment, the locking device 150-1 may be disposed on the second strap 140-2 for locking between the straps (e.g., the first strap 140-1 and the second strap 140-2). The locking device 150-1 of the second strap 140-2 may include a pin to be inserted into one of the multiple holes provided in the first strap 140-1 (e.g., hole 150).

In an embodiment, the above-described locking device 150-1 may be disposed on the first strap 140-1, and the multiple holes into which the pin of the locking device is to be inserted may be provided in the second strap 140-2.

In an embodiment, the first coupling portion 131 and the second coupling portion 132 may be fastened to the first strap 140-1. In addition, the third coupling portion 133 and the fourth coupling portion 134 may be fastened to the second strap 140-3. The description of the process and structure of fastening between the first and second coupling portions 131 and 132 and the first strap 140-1 is also applicable to the process and structurer of fastening between the third and fourth coupling portions 133 and portion 134 and the second strap 140-2.

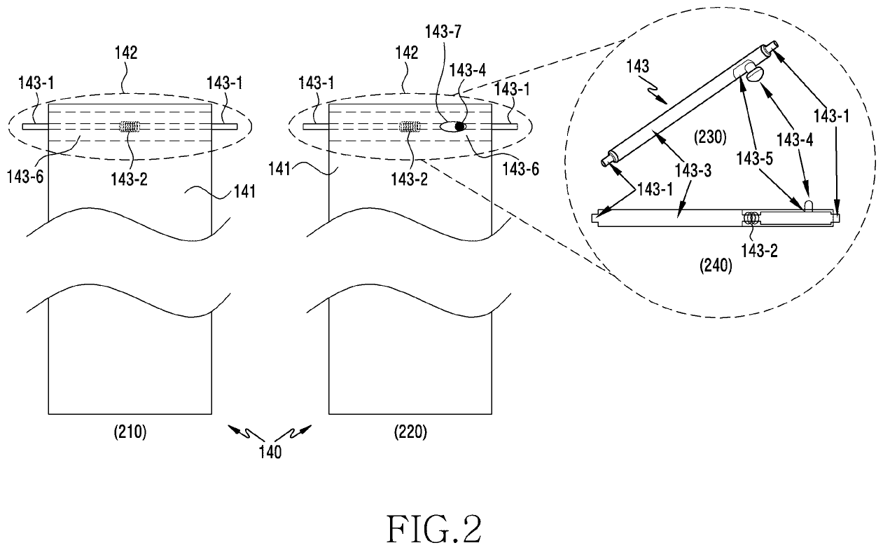

FIG. 2 is a diagram illustrating an example of a strap fastened to a wearable electronic device according to various embodiments.

According to an embodiment, 210 illustrates a portion of the first strap 140-1 when viewed from the front, and 220 illustrates a portion of the first strap 140-1 when viewed from the rear. According to an embodiment, 230 illustrates a perspective view of the fastening pin 143 included in the fastening structure 142, and 240 illustrates a side view in which the fastening pin 143 is disposed in the fastening structure 142.

In an embodiment, the first strap 140-1 may include a band 141 in addition to the fastening structure 142 to be coupled with the wearable electronic device 100.

In an embodiment, although not illustrated, when the strap 140 is the first strap 140-1, the strap 140 may include multiple holes to be coupled with the locking device (e.g., the locking device 150-1) of the second strap 140-2.

In an embodiment, the fastening structure 142 of the first strap 140-1 may be a pin spring type structure.

In an embodiment, the fastening structure 142 may include a fastening pin 143, and the fastening pin 143 may be disposed in a cover structure 143-6. For example, in the fastening structure 142, an empty space in the form of a hole inside the band 141 may be provided as a cover structure 143-6, and the fastening pin 143 may be disposed inside the cover structure 143-6 providing a hole-shaped empty space.

In an embodiment, the fastening pin 143 may include a protruding pin 143-1, at least one spring 143-2, a center pin 143-3, and a manipulation pin 143-4.

In an embodiment, the protruding pin 143-1 may be provided on each of opposite sides of the center pin 143-3. For example, the protruding pins 143 may protrude to the outside of the band 141 on the opposite sides of the center pin 143-3.

In an embodiment, at least one spring 143-2 may be coupled to the center pin 143-3. For example, at least a portion of the structure of the center pin 143-3 may be configured to be coupled with the spring 143-2, and the spring 143-2 may be located by being coupled to the portion of the structure. In addition, the spring 143-2 may be located between the protruding pins 143-1 protruding to the outside of the band 141. As another example, the center pin 143-3 may be disposed between the protruding pins 143-1, and at least one connection structure (e.g., a bracket, a spring connection structure (not illustrated) of the fastening pin 143) may be disposed between the center pin 143-3 and the spring 143-2. In addition, the center pin 143-3 and the spring 143-2 may be integrated.

In an embodiment, the material of the band 141 may be an elastic material such as rubber or another material such as leather.

In an embodiment, the band 141 may include at one end thereof an empty space (e.g., the cover structure 143-6) in which the fastening pin 143 may be disposed to be at least partially covered. In an embodiment, the at least one spring 143-2 may be covered by the exterior of the fastening pin 143. In an embodiment, in a state in which no external force is applied to the spring 143-2, the protrusion pins 143-1, the center pin 143-3, and the manipulation pin 143-4 of the fastening pin 143 may be at least partially covered by the band 141.

In an embodiment, the band 141 of the fastening structure 142 may further include a cover structure 143-6 defining a cylindrical empty space. In an embodiment, the fastening pin 143 of the fastening structure 142 may be located in the cover structure 143-6, and the band 141 may enclose the cover structure 143-6 defining the cylindrical hole.

In an embodiment, a manipulation hole 143-7 may be provided in the band 141 to allow at least a portion of the manipulation pin 143-4 (e.g., an exposed portion of the manipulation pin 143-4) to be exposed. In an embodiment, the cover structure 143-6 may include the manipulation hole 143-7 for the manipulation pin 143-4, and the cover structure 143-6 may be integrated with the manipulation hole 143-7.

In an embodiment, a hole 143-5 may be provided in the fastening pin 143 to allow at least a portion of the manipulation pin 143-4 to be exposed. For example, a housing of the fastening pin 143 may be the exterior of the center pin 143-3 and may be made of metal or non-metal, and a hole 143-5 may be provided in the housing to allow at least a portion of the manipulation pin 143-4 to be exposed.

In an embodiment, the shape of the hole 143-5 may correspond to the shape of the manipulation pin 143. In an embodiment, the size of the hole 143-5 may be greater than at least the diameter of the manipulation pin 143.

In an embodiment, the spring 143-2 may be contracted and relaxed by an external force (e.g., a user's motion), and accordingly, the lengths of the protruding portions of the protruding pins 143-1 protruding outward from the band 141 may be decreased or increased.

In an embodiment, the fastening pin 143 may include the manipulation pin 143-4 to adjust the lengths of the protruding portions of the protruding pins 143-1 protruding outward from the band 141.

In an embodiment, the manipulation pin 143-4 may be coupled with the center pin 143-3. In an embodiment, the manipulation pin 143-4 may be coupled to the center pin 143-3 via a connection member. In an embodiment, the manipulation pin 143-4 may be integrated with the center pin 143-3. In an embodiment, the manipulation pin 143-4 may be operatively connected to the spring 143-2 via the center pin 143-3. In an embodiment, the exposed portions of the manipulation pins 143-4 are portions to which a user's external force is directly applied and may transmit the external force to the spring 143-2.

In an embodiment, the center pin 143-3 may be coupled to the spring 143-2 via the connection member or may be integrated to the spring 143-2. For example, each of the center pin 143-3 and the spring 143-2 may be separately fabricated and may be connected to each other by an adhesive member and/or a connection member to form an integral body. As another example, the center pin 143-3 and the spring 143-2 may be integrated and may be integrated without using an adhesive member and/or a connection member.

In an embodiment, an external force applied to the manipulation pin 143-4 may be transmitted to the spring 143-2. For example, when a user applies an external force to the manipulation pin 143-4, the external force may be transmitted to the center pin 143-3 connected to the manipulation pin 143-4. Accordingly, the external force applied by the user may be transmitted to the spring 143-2 coupled to the center pin 143-3.

In an embodiment, the manipulation pin 143-4 may further include a cover that covers the exposed portion for a feeling of use, and the cover may be made of a material different from that of the manipulation pin 143-4. For example, the cover may be made of a material such as plastic or leather, but is not limited thereto.

In an embodiment, when the user adjusts the exposed portion of the manipulation pin 143-4, the length of the protruding portions of the protruding pins 143-1 may be adjusted due to the spring 143-2. For example, when the user contracts the spring 143-2 using the manipulation pin 143-4, the lengths of the protruding portions of the protruding pins 143-1 may be shortened, and when the user relaxes the spring 143-2 using the manipulation pin 143-2, the lengths of the protruding portions of the protruding pins 143-1 may be increased.

In an embodiment, a state in which no additional force is applied to the spring 143-2 may be defined as a first contraction state, and a state in which an external force is applied to the spring 143-2 by the user may be defined as a second contraction state. In addition, a state in which the spring 143-2 is maximally contracted may be defined as a third contraction state. For example, when the user contracts the spring 143-2 in the first contraction state using the manipulation pin 143-4, the lengths of the protruding portions of the protrusion pins 143-1 may be shortened to enter the second contraction state. In this case, when an additional external force is applied and the spring 143-2 is maximally contracted, the third contraction state may be achieved.

According to an embodiment, the description of the first strap 140-1 in FIG. 2 may also be applied to the first strap 140-1 or the second strap 140-2.

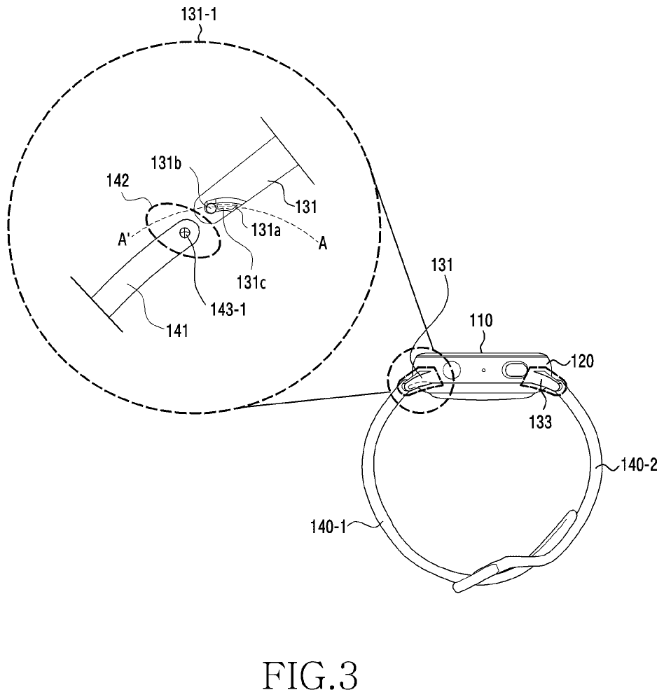

FIG. 3 is a diagram illustrating a side view of a wearable electronic device to which straps are fastened according to various embodiments. FIG. 3 illustrates a state in which the first strap 140-1 and the second strap 140-2 are coupled to the first coupling portion 131 and the third coupling portion 133, respectively. As another example, on the opposite surface to the surface of the wearable electronic device 100 illustrated in FIG. 3, the first strap 140-1 and the second strap 140-2 may be coupled to the second coupling portion 132 and the fourth coupling portion 134, respectively.

According to an embodiment, the enlarged cross-sectional view 131-1 is an enlarged partial view for explaining a state in which the first coupling portion 131 and the first strap 140-1 are coupled.

In an embodiment, a guide recess including a first recess 131a and a second recess 131b may be provided inside the first coupling portion 131. For example, the guide recess may be a structure interconnecting the first recess 131a into which a protruding pin 143-1 of the first strap 140-1 is insertable and a second recess 131b to which the protruding pin 143-1 of the first strap 140-1 is capable of being fixed.

In various embodiments, when it is described that the protruding pin 143-1 is fixed to the second recess 131b, it may refer, for example, to the protruding pin 143-1 of the fastening structure 142 being accommodated in the second recess 131b in the state in which the spring 143-2 of the fastening structure 142 is relaxed or partially contracted. For example, when the protruding pin 143-1 of the fastening structure 142 of the first strap 140-1 is accommodated in the second recess 131b, movement for use (e.g., rotation) may be possible, but the protruding pin 143-1 may not come out of the second recess 131b. The first strap 140-1 may come out of the second recess 131b only when the spring 143-2 is contracted to a predetermined length or more.

In an embodiment, the first recess 131a and the second recess 131b may be spaced apart from each other by a predetermined distance in the guide recess of the first coupling portion 131. For example, the first recess 131a and the second recess 131b may be spaced apart from each other by a predetermined distance, and the protruding pin 143-1 may move along the path A-A′ of the guide recess.

In an embodiment, the second recess 131b to which the protruding pin 143-1 is fixed for coupling the first coupling portion 131 and the first strap 140-1 may have a depth greater than that of the first recess 131a into which the protruding pin of the first strap 140-1 is inserted.

In an embodiment, the depth of a recess may refer, for example, to a length from the inner periphery of the coupling portions (e.g., the first coupling portion 131 and the second coupling portion 132) to the end of the recess. In an embodiment, the depth of a recess may change in the process of fastening the straps (e.g., the first strap 140-1 and the second strap 140-2).

In an embodiment, the depth of the first recess 131a may be a depth corresponding to the length of the protruding portion of the protruding pin 143-1 reduced by contracting the spring 143-2 of the fastening structure 142. For example, the distance between the first recess 131a in the first coupling portion 131 and the third recess 132a in the second coupling portion 132 may be determined by the depth of the first recess, and the distance may be less than the length of the fastening pin 143. An external force may be transmitted to the protruding pin 143-1 to correspond to the distance between the recesses in the fastening portions 130-1 and 130-2. The length of the protruding portion of the protruding pin 143-1 may be reduced by contracting the spring 143-2, and the depth of the first recess 131a may at least partially accommodate the reduced protruding portion. The depth of the first recess 131a may have a depth that is capable of accommodating the protruding pin 143-1 in a state in which the spring 143-2 of the fastening structure 142 is not contracted by an external force (e.g., the first contraction state). For example, the depth of the first recess 131a may be the same as or similar to the length of the second recess 131b.

In an embodiment, the depth of the second recess 131b may be a depth corresponding to the length of the spring 143-2 of the fastening structure 142 in a state of not receiving an external force so that no additional force is applied thereto (e.g., the first contraction state). For example, when the spring 143-2 is in the first contraction state, the length of the protruding portion of the protruding pin 143-1 may be the maximum, and the depth of the second recess 131b may be a depth corresponding to (e.g., equal to or greater than) the maximum length of the protruding portion. The depth of the second recess 131b may be a depth corresponding to a length in a state in which some force is applied to the protruding pin 143-1. For example, the depth of the second recess 131b is less than the maximum length of the protruding portion of the protruding pin 143-1 but may be greater than the length of the protruding portion when the protruding portion is located in the first recess 131a or the intermediate recess 131c.

In various embodiments of the disclosure, when it is described that the spring 143-2 is contracted, it may refer, for example, to a state in which the spring 143-2 is more contracted compared to the state in which no force is applied thereto, due to a force applied when the user manipulates the manipulation pin 143-4 and/or a force applied by at least a portion of the coupling portions 131 and 132 (e.g., the first recess 131a, the third recess 132a and the intermediate recesses 131c and 132c). For example, due to an arrangement structure with the protruding pin 143-1 and/or the manipulation pin 143-4, the spring 143-2 may be in a partially contracted state even when the user does not apply an additional force. Since the spring 143-2 may not be further relaxed in a state in which the spring 143-2 is arranged together with the protruding pin 143-1 and/or the manipulation pin 143-4, the spring may be described as fully relaxed for convenience of description.

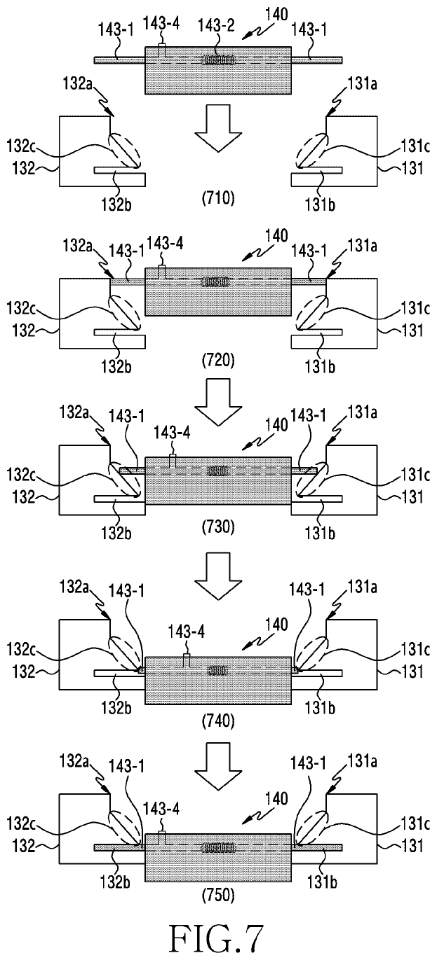

In an embodiment, the protruding pin 143-1 of the first strap 140-1 may be inserted into the first recess 131a and may be fixed to the second recess 131b. For example, the protruding pin 143-1 of the fastening structure 142 may be inserted into the guide recess through the first recess 131a, and when the protruding pin 143-1 of the fastening structure 142 is fixed to the second recess 131a, the first strap 140-1 may be coupled to the first coupling portion 131. As another example, the protruding pin 143-1 of the fastening structure 142 of the first strap 140-1 may be inserted into a recess provided in the second coupling portion 132 (e.g., the third recess 132a in FIG. 7 to be described in greater detail below) and may be fixed to a recess existing in the second coupling portion 132 (e.g., the fourth recess 132b of FIG. 7 to be described in greater detail below). When the protruding pin 143-1 of the fastening structure 142 is fixed to the recess (e.g., the fourth recess 132b in FIG. 7 to be described in greater detail below), the first strap 140-1 may be coupled to the first coupling portion 131.

In an embodiment, a guide recess including an intermediate recess 131c interconnecting the first recess 131a and the second recess 131b may be provided in the first coupling portion 131. For example, in a series of fastening processes of being inserted into the first recess 131a and fixed to the second recess 131b (the fastening processes performed along line A-A′), the protruding pin 143-1 of the fastening structure 142 of the first strap 140-1 may pass through the intermediate recess 131c.

In an embodiment, the depth of at least a portion of the intermediate recess 131c may not be greater than that of the second recess 131b. For example, when the protruding pin 143-1 is located in a portion of the intermediate recess 131c, the spring 143-2 may be in a contracted state, and at the moment when the protruding pin 143-1 is located in the second recess 131b, the contracted state of the spring 143-2 may be relaxed, and the protruding portion of the protruding pin 143-1 may be maximized In this case, since the depth of the second recess 131b is greater than the depth of the intermediate recess 131c, the maximally protruding portion of the protruding pin 143-1 may be accommodated.

In an embodiment, the depth of the intermediate recess 131c may be the same as or less than the depth of the first recess 131a. For example, the intermediate recess 131c may be smoothly connected from the first recess 131a to the second recess 131b, and may have a depth equal to or less than the depth of the first recess 131a such that the spring 143-2 may be maintained in the contracted state when the protruding pin 143-1 is located in at least a portion of the intermediate recess 131c.

In an embodiment, the depth of the intermediate recess 131c may decrease from the first recess 131a toward the second recess 131b. For example, the guide recess may have a structure inclined from at least a portion of the first recess 131a to the second recess 131b via the intermediate recess 131c.

In an embodiment, although the intermediate recess 131c has a curved line shape in FIG. 3, the intermediate recess 131c may be a recess having a straight line shape, and the shape may not be particularly limited.

According to an embodiment, the description of the coupling structure of the first coupling portion 131 and the first strap 140-1 may also be applied to the coupling structure of the second coupling portion 132 and the first strap 140-1 and the coupling structure of the third and fourth coupling portions 133 and 134 and the second strap 140-2.

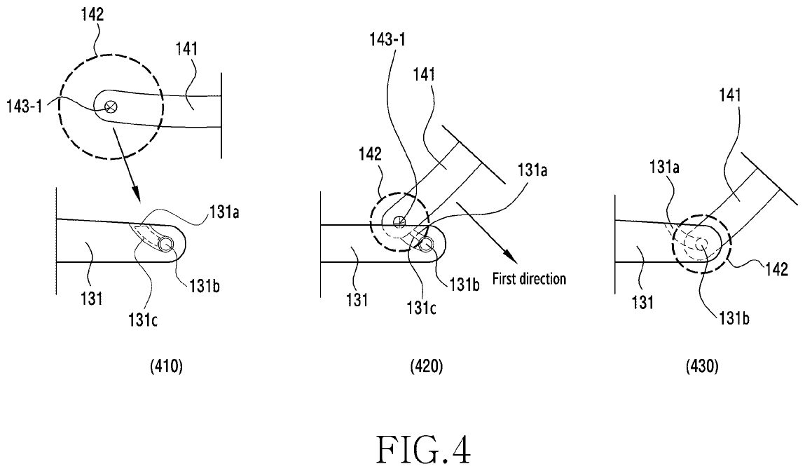

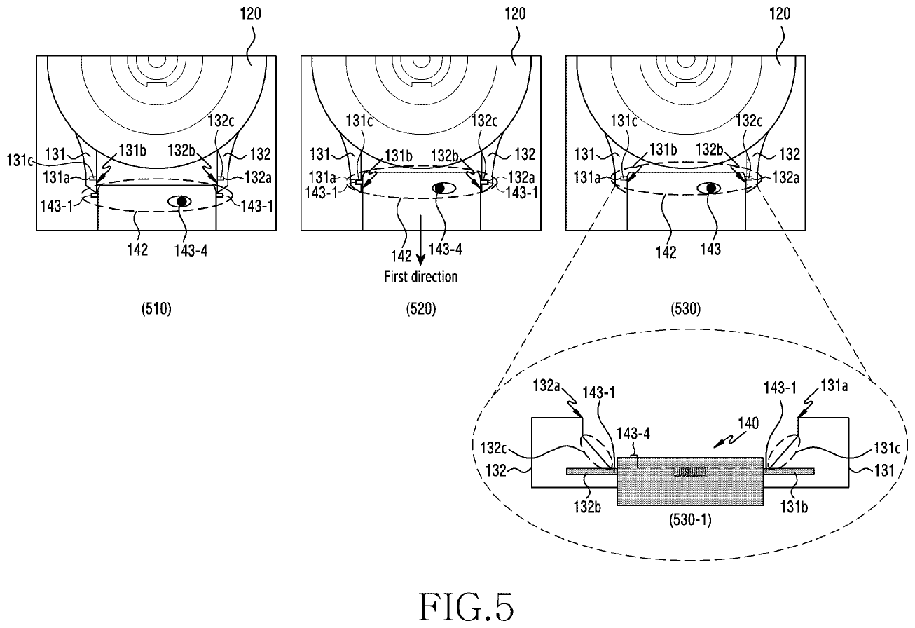

FIG. 4 is a diagram illustrating a side view of an example process of fastening a strap to a wearable electronic device according to various embodiments, and FIG. 5 is a diagram illustrating a rear view of an example process of fastening a strap to a wearable electronic device according to various embodiments.

A process of coupling the first strap 140-1 to the wearable electronic device 100 according to an embodiment will be described with reference to FIGS. 4 and 5.

In an embodiment, a user may insert the protruding pins 143-1 of the fastening structure 142 of the first strap 140-1 into recesses for insertion (e.g., the first recess 131a and the third recess 132a) provided in the first coupling portion 131 and the second coupling portion 132 of the wearable electronic device 100. According to an embodiment, the recesses for insertion (e.g., the first recess 131a and the third recess 132a) may provide openings in the outer surfaces of the first coupling portion 131 and the second coupling portion 132 when viewed from the rear. The protruding pins 143-1 of the fastening structure 142 of the first strap 140-1 may be inserted into recesses for insertion (e.g., the first recess 131a and the third recess 132a) through the openings. For example, the user may insert the protruding pins 143-1 into the first recess 131a and the third recess 132a.

In an embodiment, the user may pull the band 141 of the first strap 140-1 in a first direction in the state in which the protruding pins 143-1 of the fastening structure 142 are inserted into the first recess 131a and the third recess 132a, and the protruding pins 143-1 may enter a position where the second recess 131b and the fourth recess 132b are disposed along the intermediate recesses 131c and 132c by the user's force of pulling the band 141.

In an embodiment, as the user continues to pull the band 141 of the first strap 140-1 in the first direction, when the protruding pins 143-1 of the fastening structure 142 are fixed to the second recess 131b and the fourth recess 132b via the intermediate recesses 131c and 132c, the first strap 140-1 may be fastened to the wearable device 100.

In an embodiment, (410) and (510) may illustrate the state before the first strap 140-1 is coupled to the wearable electronic device 100.

In an embodiment, the first recess 131a may be provided in the first coupling portion 131 and the third recess 132a may be provided in the second coupling portion 132. The first recess 131a and the third recess 132a may be spaced apart from each other by a predetermined distance. For example, the predetermined distance may be a distance corresponding to the width of the fastening pin 143 corresponding to the position of the fastening structure 142 of the first strap 140-1. For example, the predetermined distance may be a distance corresponding to the sum of the width of the fastening pin 143 and the lengths of the protruding portions of the protruding pins 143-1 in the state in which the spring 143-2 of the fastening structure 142 of the first strap 140-1 is at least partially contracted. However, the predetermined distance may vary depending on a design and is not limited to the above.

In an embodiment, a guide recess including the first recess 131a, the second recess 131b, and the intermediate recess 131c may be provided in the first coupling portion 131 of the wearable electronic device 100, and a guide recess including the third recess 132a, the fourth recess (e.g., the fourth recess 132b of FIG. 7 to be described in greater detail below), and the intermediate recess (e.g., the intermediate recess 132c of FIG. 7 to be described in greater detail below) may be provided in the second coupling portion 132.

In an embodiment, the guide recess in the first coupling portion 131 may include the first recess 131a into which a protruding pin 143-1 of the fastening structure 142 of the first strap 140-1 is insertable, the second recess 131b to which the protruding pin 143-1 of the fastening structure 142 of the first strap 140-1 may be fixed, and the intermediate recess 131c interconnecting the first recess 131a and the second recess 131b.

In an embodiment, the guide recess in the second coupling portion 132 may include the third recess 132a into which a protruding pin 143-1 of the fastening structure 142 of the first strap 140-1 is insertable, the fourth recess 132b (e.g., the fourth recess 132b of FIG. 7 to be described in greater detail below) to which the protruding pin 143-1 of the fastening structure 142 of the first strap 140-1 may be fixed, and the intermediate recess 132c interconnecting the third recess 132a and the fourth recess 132b.

In an embodiment, the first recess 131a and the second recess 131b may be spaced apart from each other by a predetermined distance, the third recess 132a and the fourth recess (e.g., the fourth recess 132b of FIG. 7 to be described in greater detail below) may also be spaced apart from each other by a predetermined distance, and the intermediate recesses 131c and 132c may be provided by the predetermined distance. The above-mentioned predetermined distance may not be limited as long as the above-mentioned recesses are included in the structure of the coupling portions (e.g., the first coupling portion 131 and the second coupling portion 132).

In an embodiment, the first recess 131a and the second recess 131b may have a predetermined distance therebetween, the third recess 132a and the fourth recess (e.g., the fourth recess 132b of FIG. 7 to be described in greater detail below) may also have a predetermined distance therebetween, and the intermediate recesses 131c and 132c may be provided by the predetermined distance.

In an embodiment, the second recess 131b to which the protruding pin 143-1 of the first strap 140-1 is fixed for coupling the first coupling portion 131 and the first strap 140-1 may have a depth greater than that of the first recess 131a into which the protruding pin 143-1 of the first strap 140-1 is inserted. In addition, the fourth recess (e.g., the fourth recess 132b of FIG. 7 to be described in greater detail below) may have a depth greater than that of the third recess 132a. For example, the second recess 131b and the fourth recess 132b may have a depth greater than the lengths of the protruding portions of the protruding pins 143-1 in the state in which the spring 143-2 is relaxed.

In an embodiment, (420) and (520) illustrate a state in which the first strap 140-1 is pulled in the first direction and coupled to the wearable electronic device 100, and (430) and (530) illustrate a state in which the first strap 140-1 is coupled to the wearable electronic device 100.

In an embodiment, 530-1 is a cross-sectional view illustrating a state in which the first strap 140-1 is coupled to the wearable electronic device 100. For example, a cross-sectional view of a state in which the protruding pins 143-1 of the first strap 140-1 are coupled to the first coupling portion 131 and the second coupling portion 132 is illustrated. In an embodiment, the protruding pins 143-1 of the fastening structure 142 of the first strap 140-1 may pass through the intermediate recesses (e.g., the intermediate recesses 131c and 132c) and may be fixed to the recesses to which the fastening structure 142 is fixed (e.g., the second recess 131b and the fourth recess 132b). For example, the protruding portions of the protruding pins 143-1 of the fastening structure 142 may be fixed to the second recess 131b and the fourth recess 132b.

In an embodiment, the protruding pins 143-1 of the fastening structure 142 of the first strap 140-1 may be inserted into the first recess 131a and the third recess 132a and may be fixed to the second recess 131b and the fourth recess (e.g., the fourth recess 132b in FIG. 7 to be described in greater detail below) via the intermediate recesses (e.g., the intermediate recesses 131c and 132c). For example, the protruding pins 143-1 of the fastening structure 142 may be inserted into the guide recesses through the first recess 131a and the third recess 132a, and the protruding pins 143-1 of the fastening structure 142 may be fixed to the second recess 131b and the fourth recess (e.g., the fourth recess 132b of FIG. 7 to be described in greater detail below), so that the first strap 140-1 may be coupled to the first coupling portion 131 and the second coupling portion 132.

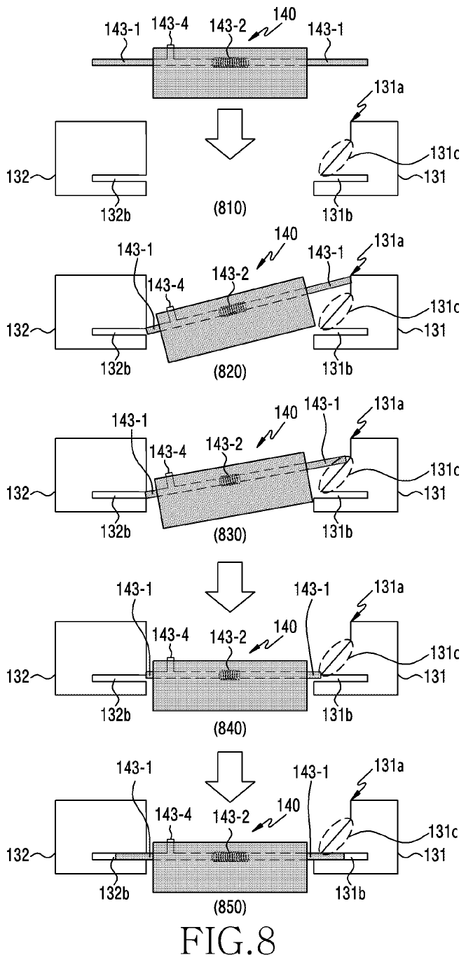

In an embodiment, a process in which the protruding pins 143-1 of the fastening structure 142 pass through the intermediate recesses (e.g., intermediate recesses 131c and 132c) in the fastening process will be described in greater detail below with reference to FIGS. 7 and 8.

The description of the coupling process according to the above-described embodiments may also be applied to the description of the process of coupling the second coupling portion 132 and the first strap 140-1 and the process of coupling the third coupling portion 133 and the fourth coupling portion 134 and the second strap 140-2.

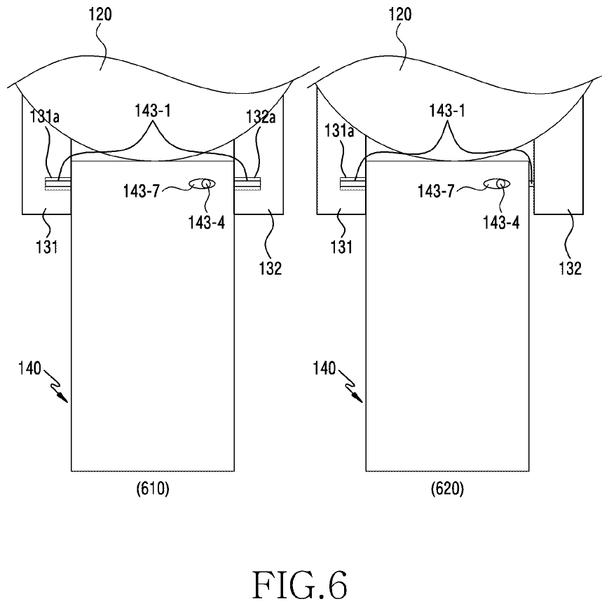

FIG. 6 is a diagram illustrating an example in which a fastening structure of a strap is inserted into a guide recess of a fastening portion existing in a frame of a wearable electronic device according to various embodiments. For example, FIG. 6 illustrates brief conceptual views for explaining a case where recesses for insertion (e.g., the first recess 131a and the third recess 132a) exist in both of the first coupling portion 131 and the second coupling portion 132 and a case where a recess (e.g., the first recess 131a or the third recess 132a) exists in one coupling portion (e.g., the first coupling portion 131).

According to an embodiment, 610 and 620 illustrate the frame 120 and the coupling portions (e.g., the first coupling portion 131 and the second coupling portion 132) when an electronic device (e.g., the electronic device 100) is viewed from the bottom. For example, 610 and 620 may illustrate the state at a time point at which the protruding pins 143-1 of the strap 140 are inserted into the first coupling portion 131 and the second coupling portion 132. FIG. 610 may illustrate an embodiment of a case in which multiple recesses for insertion exist, and FIG. 620 may illustrate an embodiment of a case in which only one recess for insertion exists.

According to an embodiment, the description of the first coupling portion 131 and the first strap 140-1 described with reference to FIGS. 3 to 5 may be equally applied to 610.

According to an embodiment, when comparing 620 with the description of the first coupling portion 131 and the first strap 140-1 described with reference to FIGS. 3 to 5, there may be a difference in that a recess for insertion and a guide recess do not exist in the second coupling portion 132 and a difference in terms of a fastening process due to the above-mentioned difference.

Hereinafter, 610 and 620 will be briefly described, and detailed descriptions of related structures and fastening processes will be described in greater detail below with reference to FIGS. 7 and 8.

In an embodiment, 610 illustrates an example in which the protruding pins 143-1 of the fastening structure 142 of the first strap 140-1 are inserted into the first coupling portion 131 including the first recess 131a and the second coupling portion 132 including the third recess 132a. To be coupled with the first coupling portion 131 and the second coupling portion 132, the protruding pins 143-1 of the first strap 140-1 may be inserted into the first recess 131a provided in the first coupling portion 131 and the third recess 132a provided in the second coupling portion 132. The process in which the protruding pins 143-1 of the first strap 140-1 are inserted into and coupled to the first recess 131a provided in the first coupling portion 131 and the third recess 132a provided in the second coupling portion 132 has been described above with reference to FIGS. 3 to 5.

In an embodiment, 620 illustrates an example in which a protruding pin 143-1 of the fastening structure 142 of the first strap 140-1 is inserted into the first coupling portion 131 in which the first recess 131a is provided and the second coupling portion 132 in which no recess is provided. For example, the first recess 131a into which the protruding pin 143-1 of the fastening structure 142 is insertable is provided in the first coupling portion 131, but a recess for insertion may not be provided in the second coupling portion 132. In this case, one of the protruding pins 143-1 of the fastening structure 142 of the first strap 140-1 may be inserted into the first recess 131a provided in the first coupling portion 131, and the other one of the protruding pins 143-1 may be inserted into the fourth recess (e.g., the fourth recess 132b) provided in the second coupling portion 132 without passing through a recess for insertion in a state in which the length thereof is shortened by the contraction of the spring 143-2. After the protruding pin 143-1 of the fastening structure 142 of the first strap 140-1 is inserted into the guide recess in the first coupling portion 131, the fastening structure may be simultaneously fixed to the second recess (e.g., the second recess 131b) provided in the first coupling portion 131 and the fourth recess (e.g., the fourth recess 132b of FIG. 7 to be described in greater detail below) provided in the second coupling portion 132.

FIG. 7 is a diagram illustrating an example process in which a fastening structure of a strap is inserted into and fastened to guide recesses of a fastening portion existing in a frame of a wearable electronic device according to various embodiments.

FIG. 7 may illustrate cross-sectional views obtained by cutting the first coupling portion 131 and the second coupling portion 132 from the insertion recesses 131a and 132a along the intermediate recesses 131c and 132c and through the fixing recesses 131b and 132b. Referring to FIG. 7, the fastening structure 142 of the first strap 140-1 may be coupled to the coupling portions (e.g., the first coupling portion 131 and the second coupling portion 132) existing in the frame (e.g., the frame 120) of a wearable electronic device (e.g., the wearable electronic device 100) by passing through states (710) to (750).

In an embodiment, the spring 143-2 in state (710) may be in the first contraction state, the spring 143-2 in states (720) to (730) may be in the second contraction state, and the spring 143-2 in state (740) may be in the third contraction state. In an embodiment, the spring 143-2 in state (750) may be in the first contraction state.

In state (710) according to an embodiment, a state in which the fastening structure 142 of the first strap 140-1 is separated from the wearable electronic device 100 is illustrated.

In an embodiment, the first coupling portion 131 may be provided with a first recess 131a into which one pin 142-1 of the fastening structure 142 is insertable, and the second coupling portion 132 may be provided with a third recess 132a into which the other pin 142-2 of the fastening structure 142 is insertable.

In an embodiment, the first coupling portion 131 of the wearable electronic device 100 may be provided with a guide recess including a first recess 131a and a second recess 131b. In addition, the guide recess may include an intermediate recess 131c which is an intermediate structure interconnecting the first recess 131a and the second recess 131b.

In an embodiment, the second coupling portion 132 of the wearable electronic device 100 may be provided with a guide recess including a third recess 132a and a fourth recess 132b. In addition, the guide recess may include an intermediate recess 132c which is an intermediate structure interconnecting the third recess 132a and the fourth recess 132b.

In an embodiment, the recesses into which the fastening structure 142 is inserted (e.g., the first recess 131a and the third recess 132a) may have depths greater than those of the recesses to which the fastening structure 142 is fixed (e.g., the second recess 131b and the fourth recess 132b), but the disclosure is not limited thereto. For example, although not illustrated, the depths of the recesses into which the fastening structure 142 is inserted (e.g., the first recess 131a and the third recess 132a) may be equal or similar to or greater than the depths of the recesses to which the fastening structure 142 is fixed (e.g., the second recess 131b and the fourth recess 132b).

The depths of the intermediate recesses 131c and 132c according to an embodiment may decrease from the recesses into which the fastening structure 142 is inserted (e.g., the first recess 131a and the third recess 132a) toward recesses to which the fastening structure 142 is fixed (e.g., the second recess 131b and the fourth recess 132b).

In an embodiment, there may be no particular limitation on the shape of the intermediate recesses 131c and 132c interconnecting the recesses into which the fastening structure 142 is inserted (e.g., the first recess 131a and the third recess 132a) and the recesses to which the fastening structure 142 is fixed (e.g., the second recess 131b and the fourth recess 132b). For example, the intermediate recesses 131c and 132c may interconnect recesses (e.g., the first recess 131a and third recess 132a) and recesses (e.g., second recess 131b and the fourth recess 132b) in a straight line shape. As another example, the intermediate recesses 131c and 132c may interconnect recesses (e.g., the first recess 131a and third recess 132a) and recesses (e.g., second recess 131b and the fourth recess 132b) in a curved line shape.

State (720) according to an embodiment may be the state at a time point at which the protruding pins 143-1 of the fastening structure 142 of the first strap 140-1 are inserted into the coupling portions (e.g., the first coupling portion 131 and the second coupling portion 132).

In an embodiment, the protruding pins 143-1 may be inserted into recesses for insertion (e.g., the first recess 131a and the third recess 132a) provided in the coupling portions (e.g., the first coupling portion 131 and the second coupling portion 132). In an embodiment, the protruding portions of the protruding pins 143-1 may be inserted into recesses into which the first coupling portion 131 and the second coupling portion 132 are inserted (e.g., the first recess 131a, the third recess 132a). For example, when the user applies a force to the first strap 140-1 in a first direction at the entrances of the recesses into which the protruding portions of the protruding pins 143-1 are inserted (e.g., the first recess 131a and the third recess 132a), the protruding pins 143-1 may be inserted into the first recess 131a and/or the third recess 132a. According to various embodiments, the protruding pins 143-1 may be inserted into the recesses for insertion in the first coupling portion 131 and the second coupling portion 132 (e.g., the first recess 131a and the third recess 132a) in the state in which the protruding portions of the protruding pins 143-1 are shortened by contracting the spring 143-2 using the manipulation pin 143-4.

In operations (730) and (740) according to an embodiment, the protruding portions of the protruding pins 143-1 of the first strap 140-1 may move toward the recesses to which the fastening structure 142 is fixed (e.g., the second recess 131b and the fourth recess 132b) along the intermediate recesses (e.g., intermediate recesses 131c and 132c) by an external force applied by the user.

In an embodiment, the protruding pins 143-1 of the fastening structure 142 of the first strap 140-1 may enter the guide recesses in the coupling portions (e.g., the first coupling portion 131 and the second coupling portion 132) via recesses (e.g., the first recess 131a and the third recess 132a) provided in the coupling portions (e.g., the first coupling portion 131 and the second coupling portion 132).

In an embodiment, as the fastening structure 142 approaches the recesses for fixing (e.g., the second recess 131b and the fourth recess 132b), the spring 143-2 may be contracted even when the user does not manipulate the pin manipulation portion 143 since the distance between the intermediate recesses (e.g., the intermediate recesses 131c and 132c) is reduced. For example, the distance (or length) between the intermediate recess 131c and the intermediate recess 132c may be reduced toward the recesses for fixing the fastening structure 142. As the spring 143-2 built in the fastening structure 142 is contracted or relaxed, the length of the protruding portion of the protruding pin 143-1 may decrease or increase, and as the distance between the intermediate recess 131c and the intermediate recess 132c is reduced, the spring 143-2 of the fastening structure 142 may be contracted and the lengths of the protruding portions of the protruding pins 143-1 may decrease.

In an embodiment, when the protruding pins 143-1 of the fastening structure 142 pass through the boundary between the intermediate recesses 131c and 132c and the recesses for fixing (e.g., the second recess 131b and the fourth recess 132b), the lengths of the protruding portions of the protruding pins 143-1 may increase. For example, since the recesses for fixing (e.g., the second recess 131b and the fourth recess 132b) have a depth greater than that of the intermediate recesses 131c and 132c, a difference in depth may exist, and the spring 143-2 inside the fastening structure 142 may be gradually contracted in the intermediate recesses 131c and 132c and may be then relaxed in the recesses for fixing (e.g., the second recess 131b and the fourth recess 132b). An external force acting on the protruding pins 143-1 of the fastening structure 142 from the intermediate recesses 131c and 132c may not act or may act more weakly due to a difference in depth in the recesses for fixing (e.g., the second recess 131b and the fourth recess 132b). Accordingly, since the spring 143-2 is relaxed, the lengths of the protruding portions of the protruding pins 143-1 may increase.

In operation (750) according to an embodiment, the protruding pins 143-1 of the fastening structure 142 of the first strap 140-1 may pass through the intermediate recesses (e.g., the intermediate recesses 131c and 132c) and may be fixed to the recesses to which the fastening structure 142 is fixed (e.g., the second recess 131b and the fourth recess 132b). For example, the protruding portions of the protruding pins 143-1 of the fastening structure 142 may increase in length due to the relaxation of the spring 143-2, and the protruding pins 143-1 having increased lengths may be fixed to the second recess 131b and the fourth recess 132b.

FIG. 8 is a diagram illustrating an example process in which a fastening structure of a strap is inserted into and fastened to guide recesses of a fastening portion existing in a frame of a wearable electronic device according to various embodiments.

FIG. 8 may illustrate cross-sectional views obtained by cutting the first coupling portion 131 and the second coupling portion 132 from insertion recesses (the first recess 131a and the second 132a) along the intermediate recesses 131c and 132c, and through the fixing recesses (e.g., the second recess 131b and the fourth recess 132b).

Referring to FIG. 8, the fastening structure 142 of the first strap 140-1 may be coupled to the coupling portions (e.g., the first coupling portion 131 and the second coupling portion 132) existing in the frame (e.g., the frame 120) of a wearable electronic device (e.g., the wearable electronic device 100) by passing through states (810) to (850).

In an embodiment, the spring 143-2 in state (810) may be in the first contraction state, the spring 143-2 in states (820) to (830) may be in the second contraction state, and the spring 143-2 in state (840) may be in the third contraction state. In an embodiment, the spring 143-2 in state (850) may be in the first contraction state.

In state (810) according to an embodiment, a state in which the fastening structure 142 of the first strap 140-1 is separated from the wearable electronic device 100 is illustrated.

In an embodiment, a first recess 131a into which the protruding pin 143-1 of the fastening structure 142 is insertable may be provided in the first coupling portion 131, and a recess for insertion may not be provided in the second coupling portion 132.

In an embodiment, the first coupling portion 131 of the wearable electronic device 100 may be provided with a guide recess including a first recess 131a and a second recess 131b. In addition, the guide recess may include an intermediate recess 131c which is an intermediate structure interconnecting the first recess 131a and the second recess 131b.

In an embodiment, a recess for insertion (e.g., the third recess 132a of FIG. 7) may not be provided in the second coupling portion 132 of the wearable electronic device 100.

In an embodiment, the depth of the recesses to which the protruding pin 143-1 of the fastening structure 142 is fixed (e.g., the second recess 131b and the fourth recess 131b) may be greater than the depth of the recess to which the protruding pin 143-1 of the fastening structure 142 is inserted (e.g., the first recess 131a). In addition, the depth of the intermediate recess 131c may decrease from the recess into which the protruding pin 143-1 of the fastening structure 142 is inserted (e.g., the first recess 131a) toward the recesses to which the fastening structure 142 is fixed (e.g., the second recess 131a and the fourth recess 132b).

In an embodiment, there may be no particular limitation on the shape of the intermediate recess 131c which interconnects the recess into which the protruding pin 143-1 of the fastening structure 142 is inserted (e.g., the first recess 131a) and the recess to which the protruding pin 143-1 of the fastening structure 142 is fixed (e.g., the second recess 131b). For example, the intermediate recess 131c may interconnect a recess (e.g., the first recess 131a) and a recess (e.g., the second recess 131b) in a straight line shape. As another example, the intermediate recess 131c may interconnect a recess (e.g., the first recess 131a) and a recess (e.g., the second recess 131b) in a curved line shape.

State (820) according to an embodiment may illustrate the state at a time point at which the protruding pins 143-1 are inserted into the coupling portions (e.g., the first coupling portion 131 and the second coupling portion 132).

In an embodiment, one of the protruding pins 143-1 of the fastening structure 142 may be seated in the first recess 131a, and the other one of the protruding pins 143-1 may be inserted into the fourth recess 132b.

In states (830) and (840) according to an embodiment, the other one of the protruding pins 143-1 of the fastening structure 142 of the first strap 140-1 may move toward the recess to which the fastening structure 142 is fixed (e.g., the second recess 131b and the fourth recess 132b) along the intermediate recess (e.g., the intermediate recess 131c).

In an embodiment, one of the protruding pins 143-1 of the fastening structure 142 of the first strap 140-1 may be directly fixed to the fourth recess 132b provided in the second coupling portion 132. For example, since a recess for insertion and a guide recess are not provided in the second coupling portion 132, one of the protruding pins 143-1 of the fastening structure 142 may be directly fixed to the fourth recess 132b without passing through the guide recess.

In an embodiment, the other one of the protruding pins 143-1 of the fastening structure 142 of the first strap 140-1 may enter the guide recess in the first coupling portion 131 through the first recess 131a provided in the first coupling portion 131.

In an embodiment, as the other one of the protruding pins 143-1 of the fastening structure 142 approaches the second recess 131b for fixation, the spring 143-2 of the fastening structure 142 may be contracted even when the manipulation pin 143-4 is not manipulated by the user since the depth of the intermediate recess (e.g., the intermediate recess 131c) decreases. For example, the depth of the intermediate recess 131c may decrease as the other one of the protruding pins 143-1 of the fastening structure 142 moves toward the recess for fixing. Accordingly, as the spring 143-2 of the fastening structure 142 is contracted by an external force as the other one of the protruding pins 143-1 moves toward the recess for fixing, the lengths of the protruding portions of the protruding pin 143-1 may decrease.

In an embodiment, the second recess 131b and the fourth recess 132b provided in the coupling portions (e.g., the first coupling portion 131 and the second coupling portion 132) may have a depth greater than that of the first recess 131a for insertion or that of at least a portion of the intermediate recess 131c.

In an embodiment, the second recess 131b and the fourth recess 132b provided in the coupling portions (e.g., the first coupling portion 131 and the second coupling portion 132) may have a depth corresponding to that of the first recess 131a for insertion.

In an embodiment, the lengths of the protruding portions of the protruding pins 143-1 may increase after passing through the boundary between the intermediate recess 131c and the recess for fixing (e.g., the second recess 131b). For example, the recess for fixing (e.g., the second recess 131b) may have a depth greater than the boundary between the intermediate recess 131c and the recess for fixing (e.g., the second recess 131b). Accordingly, there may be a depth difference in depth. The spring 143-2 inside the fastening structure 142 may be gradually contracted while passing through the intermediate recess 131c and may then relaxed at the position of the recess for fixing (e.g., the second recess 131b). An external force acting on the protruding pins 143-1 of the fastening structure 142 from the intermediate recesses 131c may not act or may act weakly due to the difference in depth in the recess for fixing (e.g., the second recess 131b), and since the spring 143-2 is relaxed, the lengths of the protruding portions of the protruding pins 143-1 may increase.

In state (850) according to an embodiment, the protruding pins 143-1 of the fastening structure 142 of the first strap 140-1 may pass through the intermediate recess (e.g., the intermediate recess 131c) and may be fixed to the recesses to which the protruding pins 143-1 are fixed (e.g., the second recess 131b and the fourth recess 132b). For example, the protruding portions of the protruding pins 143-1 of the fastening structure 142 may increase in length due to the relaxation of the spring 143-2, and the protruding portions of the protruding pins 143-1 having increased lengths may be fixed to the second recess 131b and the fourth recess 132b, respectively.

A wearable electronic device (e.g., the wearable electronic device 100) according to an example embodiment may include: a display (e.g., the display 110) defining the front surface of the wearable electronic device (e.g., the wearable electronic device 100), and a frame (e.g., the frame 120) surrounding the display (e.g., the display 110) and defining at least a portion of the exterior of the wearable electronic device (e.g., the wearable electronic device 100). The frame (e.g., the frame 120) may include a fastening portion (e.g., 130-1 or 130-2) to which a strap (e.g., 140-1 or 140-2) configured to assist the wearing of the wearable electronic device (e.g., the wearable electronic device 100) is configured to be coupled. The fastening portion (e.g., 130-1 or 130-2) may include a first coupling portion (e.g., the first coupling portion 131) and a second coupling portion (e.g., the second coupling portion 132) disposed to be spaced apart from the first coupling portion (e.g., the first coupling portion 131) by a specified distance. The first coupling portion (e.g., the first coupling portion 131) may include a first recess into which a fastening structure of the strap (e.g., 140-1 or 140-2) may be inserted (e.g., the first recess 131a), and a second recess to which the fastening structure of the strap (e.g., 140-1 or 140-2) may be fixed (e.g., the second recess 131b). The second coupling portion (e.g., the second coupling portion 132) includes a fourth recess (e.g., the fourth recess 132b) to which the fastening structure of the strap (e.g., 140-1 or 140-2) may be fixed. The fastening structure of the strap (e.g., 140-1 or 140-2) may include protruding pins (e.g., the protruding pins 143-1), and the protruding pins (e.g., the protruding pin 143-1) may be configured to be inserted into at least the first recess (e.g., the first recess 131a) and fixed to the second recess (e.g., the second recess 131b) and the fourth recess (e.g., the fourth recess 132b), respectively.

In the wearable electronic device (e.g., the electronic device 100) according to an example embodiment, the fastening structure of the strap (e.g., 140-1 or 140-2) may include a pin spring type.

In the wearable electronic device (e.g., the wearable electronic device 100) according to an example embodiment, a first intermediate recess (e.g., the intermediate recess 131c) through which the fastening structure of the strap (e.g., 140-1 or 140-2) is capable of passing may be disposed between the first recess (e.g., the first recess 131a) and the second recess (e.g., the second recess 131b).

In the wearable electronic device (e.g., the wearable electronic device 100) according to an example embodiment, the first recess (e.g., the first recess 131a), the second recess (e.g., the second recess 131b), and the first intermediate recess (e.g., the intermediate recess 131c) may provide a first guide recess as an integral structure.

In the wearable electronic device (e.g., the wearable electronic device 100) according to an example embodiment, the first intermediate recess (e.g., the intermediate recess 131c) may interconnect the first recess (e.g., the first recess 131a) and the second recess (e.g., the second recess 131b) in a curved line shape.

In the wearable electronic device (e.g., the wearable electronic device 100) according to an example embodiment, the first intermediate recess (e.g., the intermediate recess 131c) may interconnect the first recess (e.g., the first recess 131a) and the second recess (e.g., the second recess 131b) in a straight line or curved line shape.

In the wearable electronic device (e.g., the wearable electronic device 100) according to an example embodiment, the second recess (e.g., the second recess 131b) and the fourth recess (e.g., the fourth recess 132b) may be disposed in the first coupling portion (e.g., the first coupling portion 131) and the second coupling portion (e.g., the second coupling portion 132) at mutually corresponding positions, respectively.

In the wearable electronic device (e.g., the wearable electronic device 100) according to an example embodiment, the fourth recess (e.g., the fourth recess 132b) may have a depth greater than that of the first recess (e.g., the first recess 131a) or the second recess (e.g., the second recess 131b).

In the wearable electronic device (e.g., the wearable electronic device 100) according to an example embodiment, the second coupling portion (e.g., the second coupling portion 132) may include a third recess into which the fastening structure of the strap (e.g., 140-1 or 140-2) is insertable (e.g., the third recess 132a).

In the wearable electronic device (e.g., the wearable electronic device 100) according to an example embodiment, a second intermediate recess (e.g., the intermediate recess 132c) through which the fastening structure of the strap (e.g., 140-1 or 140-2) is capable of passing may be disposed between the third recess (e.g., the third recess 132a) and the fourth recess (e.g., the fourth recess 132b).

In the wearable electronic device (e.g., the wearable electronic device 100) according to an example embodiment, the third recess (e.g., the third recess 132a), the fourth recess (e.g., the fourth recess 132b), and the second intermediate recess (e.g., the intermediate recess 132c) may provide a second guide recess as an integral structure.

In the wearable electronic device (e.g., the wearable electronic device 100) according to an example embodiment, the second recess (e.g., the second recess 131b) and the fourth recess (e.g., the fourth recess 132b) may be disposed in the first coupling portion (e.g., the first coupling portion 131) and the second coupling portion (e.g., the second coupling portion 132) at mutually corresponding positions, respectively.

In the wearable electronic device (e.g., the wearable electronic device 100) according to an example embodiment, the third recess (e.g., the third recess 132a) and the fourth recess (e.g., the fourth recess 132b) may have depths greater than those of the first recess (e.g., the first recess 131a) and the second recess (e.g., the second recess 131b).

In the wearable electronic device (e.g., the wearable electronic device 100) according to an example embodiment, the second intermediate recess (e.g., the intermediate recess 132c) may interconnect the first recess (e.g., the first recess 131a) and the second recess (e.g., the second recess 131b) in a curved line shape.

In the wearable electronic device (e.g., the wearable electronic device 100) according to an example embodiment, the intermediate recess may interconnect the first recess (e.g., the first recess 131a) and the second recess (e.g., the second recess 131b) in a straight line shape.

In the wearable electronic device (e.g., the wearable electronic device 100) according to an example embodiment, the second recess (e.g., the second recess 131b) may be provided outside the first recess (e.g., the first recess 131a) in the wearable electronic device (e.g., the wearable electronic device 100).

In the wearable electronic device (e.g., the wearable electronic device 100) according to an example embodiment, the first coupling portion (e.g., the first coupling portion 131) may be provided with a first guide recess including the first recess (e.g., the first recess 131a) and the second recess (e.g., the second recess 131b), and the second coupling portion (e.g., the second coupling portion 132) may be provided with a second guide recess including a third recess (e.g., the third recess 132a) and the fourth recess into which the fastening structure of the strap (e.g., 140-1 or 140-2) is insertable (e.g., the fourth recess 132b).

In the wearable electronic device (e.g., the wearable electronic device 100) according to an example embodiment, the first guide recess and the second guide recess may be disposed to be spaced apart from each other.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A wearable electronic device comprising:
a display defining a front surface of the wearable electronic device; and
a frame surrounding the display and defining at least a portion of an exterior of the wearable electronic device,
wherein the frame comprises a fastening portion to which a strap configured to assist the wearing of the wearable electronic device is configured to be coupled,
the fastening portion comprises a first coupling portion and a second coupling portion disposed to be spaced apart from the first coupling portion by a specified distance,
the first coupling portion comprises a first recess into which a fastening structure of the strap is configured to be inserted, and a second recess to which the fastening structure of the strap is configured to be fixed,
the second coupling portion comprises a fourth recess to which the fastening structure of the strap is configured to be fixed, and
the fastening structure of the strap includes protruding pins, which are configured to be inserted into at least the first recess and fixed to the second recess and the fourth recess, respectively.

2. The wearable electronic device of claim 1, wherein the fastening structure of the strap comprises a pin spring type.

3. The wearable electronic device of claim 1, wherein a first intermediate recess through which the fastening structure of the strap is capable of passing is disposed between the first recess and the second recess.

4. The wearable electronic device of claim 3, wherein the first recess, the second recess, and the first intermediate recess provide a first guide recess as an integral structure.

5. The wearable electronic device of claim 3, wherein the first intermediate recess interconnects the first recess and the second recess in a curved line shape.

6. The wearable electronic device of claim 3, wherein the first intermediate recess interconnects the first recess and the second recess in a straight line or curved line shape.

7. The wearable electronic device of claim 1, wherein the second recess and the fourth recess are disposed in the first coupling portion and the second coupling portion at mutually corresponding positions, respectively.

8. The wearable electronic device of claim 1, wherein the fourth recess has a depth greater than a depth of the first recess or the second recess.

9. The wearable electronic device of claim 1, wherein the second coupling portion comprises a third recess into which the fastening structure of the strap is insertable.

10. The wearable electronic device of claim 9, wherein a second intermediate recess through which the fastening structure of the strap is capable of passing is disposed between the third recess and the fourth recess.

11. The wearable electronic device of claim 10, wherein the third recess, the fourth recess, and the second intermediate recess provide a second guide recess as an integral structure.

12. The wearable electronic device of claim 10, wherein the second recess and the fourth recess are disposed in the first coupling portion and the second coupling portion at mutually corresponding positions, respectively.

13. The wearable electronic device of claim 10, wherein the third recess and the fourth recess have depths greater than depths of the first recess and the second recess.

14. The wearable electronic device of claim 10, wherein the second intermediate recess interconnects the first recess and the second recess in a curved line shape.

15. The wearable electronic device of claim 10, wherein the intermediate recess interconnects the first recess and the second recess in a straight line shape.
